(19) United States
(12) Patent Application Publication
(10) Pub. No.: US 2016/0213193 A1
(43) Pub. Date: Jul. 28, 2016

(54) BEVERAGE PREPARATION APPARATUS WITH CENTRAL CONSTANT TEMPERATURE WATER SUPPLY

(71) Applicant: GINO CREATION CO., LTD., Taipei City (TW)

(72) Inventor: TSUNG-HSI LIU, Taipei City (TW)

(73) Assignee: GINO CREATION CO., LTD., Taipei City (TW)

(21) Appl. No.: 14/916,525

(22) PCT Filed: Sep. 23, 2013
(86) PCT No.: PCT/CN2013/001122

§ 371 Date: Mar. 3, 2016

(51) Int. Cl. A47J 31/56; F24H 9/20; F24H 9/12; F24H 9/14; F24H 1/08; F24H 1/18

(52) U.S. Cl. CPC A47J 31/56; F24H 1/08; F24H 1/18; F24H 9/126; F24H 9/14; F24H 9/2007

(57) ABSTRACT

Provided is a beverage preparation apparatus having a central constant temperature water supply. The hot water furnace heats water to a predetermine temperature and supplies hot water to at least one hot water branch via a hot water supply line. Different beverage preparation modules are mounted to the hot water branch. Hot water and beverage materials are mixed in the beverage preparation module to prepare beverage. A return pipe interconnects the hot water furnace and the hot water supply line. In response to flowing hot water to the hot water supply line, the solenoid valves for water branch are closed and the solenoid valve for return pipe is open so that hot water flows to the hot water furnace via the return pipe. The hot water flow stops when the temperature sensor senses temperature of the hot water flow in the return pipe is equal to the predetermined temperature.

### BACKGROUND OF THE INVENTION

1. Field of the Invention

The invention relates to beverage preparation apparatuses and more particularly to a beverage preparation apparatus having a central constant temperature water supply capable of supplying water of a predetermined temperature to respective beverage preparation modules.

2. Description of Related Art

Conventionally, a beverage preparation device is used to make coffee, tea or other beverage. The conventional beverage preparation device in preparing beverage activates a water pump to draw external water to a boiler, activates heating devices such as heater and heat exchanger to heat the water to a set temperature, supplies the water to a dispenser via a supply line system, and activates the dispenser to supply hot water to a beverage preparation container, thereby beginning to prepare beverage.

The above described preparation of beverage by drawing external water and heating same in a conventional manner, it involves quickly heating the cold water to a set temperature. Thus it has many disadvantages as discussed below.

To maintain a steady supply of water having a desired temperature, it is necessary to use a powerful heating device having high power consumption, resulting in energy waste.

In the water supply of the beverage preparation, it is difficult of maintaining hot water at a constant temperature, particularly in the preparation of tea-based beverages. The heating device is not capable of heating a large quantity of water in a short period of time. Thus, supplied water becomes less hot, resulting in poor quality of the beverage and less tasty.

Time is required to heat cold water to a set temperature. Thus, the conventional beverage preparation device's beverage preparation efficiency is low and clients typically need to wait for a period of time.

A complete set of the hot water system including boilers, heaters, heat exchangers, various temperature control assemblies, and for example, electromagnetic valve, flow meter, one-way relief valves, throttle valves and the like can only supply hot water to single liquid dispensers and beverage preparation vessels for preparing a single beverage, resulting in bulkiness of each beverage preparation device. Further, it is cost expensive. For existing beverage industry, a number of standalone beverage preparation devices are required to install in a store to meet business needs. However, it not only occupies store space and it is cost expensive to purchase the machines.

Taiwan Utility Model Number M247802 discloses a control device for a water dispenser. The water dispenser has a reservoir, a water inlet close to lower portion of cartridge walls. The reservoir is further provided with a water level controller, temperature sensing controllers, heaters and temperature display. The water level controller is on top of the water level controller and in the reservoir provided with short, median and long rods for sensing water level. The temperature sensing controller is below the outlet. The Utility Model is characterized by the following: the intake water control activates when cold water flows from the water inlet into the reservoir and the water level reaches the long rod, i.e., water is stopped from flowing into the reservoir and the heater begins to heat until water temperature rises to a preset temperature. It is because water level does not reach the short rod, the intake water solenoid valve controls the intake water into the reservoir. Water in the reservoir is mixed to cause water temperature drop. The water solenoid valve is controlled to stop water from flowing in, and the heater heats, and repeating the water flow in and heating until water level in the reservoir reaches the short rod position and water is heated to boiling. After boiling, water is stopped from feed and the heating is stopped. After water in the reservoir falls to the bottom of the short rod, the water level controller and the temperature sensor activate a water inlet electromagnetic valve to begin water feeding and activate the heater. Water in the reservoir begins to heat to a boiling temperature again for human consumption. The above arrangement allows the reservoir to keep hot water at full so as to provide a large quantity of hot water at any time.

For beverage preparation device, hot water having a constant temperature is essential to the provision of good drinking quality and taste. Different types of beverages each have different optimal brewing temperature, for example, using 95° C. hot water to brew tea, using 85° C. hot water to brew green tea. Thus, in beverage preparation, how to maintain the supplied water at a constant first temperature is an issue to be addressed at the beverage preparation device.

Taiwan Utility Model Number M247802 and commercially available water dispensers do not supply water at a constant first temperature and there is no provision of automatic hot water supply having a constant temperature. Thus they are not suitable to the beverage preparation devices having a constant temperature water supply requirement.

### SUMMARY OF THE INVENTION

It is therefore one object of the invention to provide a beverage preparation apparatus primarily employing a central water supply system to supply warm water to each beverage preparation module for preparing various beverages. The central water supply apparatus may more effectively maintain hot water at a predetermined temperature, supply a large quantity of hot water to brew beverages in a short period of time, greatly improve efficiency of the beverage preparation apparatus, and prepare various beverages of quality and good taste.

Another object of the invention is to provide a beverage preparation apparatus having a central constant temperature water supply. The central water supply system may preheat water to a first temperature in an off-peak time. It not only avoids the use of heating device of high power consumption but also utilizes a relatively inexpensive off-peak power, thereby effectively reducing beverage preparation cost.

Another object of the invention is to provide a beverage preparation apparatus having a central constant temperature water supply in a modular way. A variety of beverage preparation modules are used in conjunction with the central water supply apparatus. Depending on a beverage preparation operator's actual needs, the central water supply apparatus may install or remove beverage preparation modules. It not only meets the business needs but also saves space of a store.

Another object of the invention is to provide a beverage preparation apparatus having a central constant temperature water supply with beverage preparation modules. Each can be selected to draw hot water from the central supply. Alternatively, an additional heating device is added to the beverage preparation module for simplifying construction and reducing the cost of manufacturing the beverage preparation apparatus.

For achieving above and other purposes, the invention provides a beverage preparation apparatus comprising a hot water furnace for storing a quantity of water, the hot water furnace including a heater for heating water in the hot water furnace to a first predetermined temperature, a first temperature sensor for sensing water temperature in the hot water furnace, a water supply line for flowing cold water to the hot water furnace, and a plurality of water level sensors for sensing water level in the hot water furnace; at least one hot water supply line for flowing hot water out of the hot water furnace, the hot water supply line including a hot water pump for pumping hot water out of the hot water furnace and a solenoid valve for water supply for controlling opening or close of the hot water supply line; a plurality of hot water branches connected to the hot water supply line, each of the hot water branches including a solenoid valve for water branch for controlling opening or close of the hot water branch; a plurality of beverage preparation modules mounted to the hot water branches, each of the beverage preparation modules including a container for storing predetermined beverage materials wherein when the corresponding solenoid valve for water branch is open, hot water in the hot water supply line flows into the container to mix with the beverage materials to prepare beverage; and a return pipe interconnecting the hot water furnace and the hot water supply line, the return pipe including a second temperature sensor and a solenoid valve for return pipe for controlling opening or close of the return pipe; wherein in response to flowing hot water to the hot water supply line, the solenoid valves for water branch are closed and the solenoid valve for return pipe is open so that hot water in the hot water supply line is configured to flow to the hot water furnace via the return pipe; and the hot water flow stops when the second temperature sensor senses temperature of the hot water flow in the return pipe is equal to the first predetermined temperature.

In a preferred embodiment of the invention, there is provided with a water supply line connecting the hot water furnace for supplying cold water thereto, and a plurality of water level sensors include a low water level sensor, an intermediate water level sensor, a high water level sensor, and an upper limit level sensor; and wherein the low water level sensor is slightly above the water supply line, when water level of the hot water furnace is lower than the low water level sensor, the beverage preparation apparatus stops hot water supply, cuts off power of the heater and the hot water pump, and issues a warning, after stopping issuing the warning and water level in the hot water furnace reaching the intermediate water level sensor, the water supply line is close by turning off power, the heater heats water, the water supply line supplies cold water to the hot water furnace again when the first temperature sensor senses water temperature in the hot water furnace is equal to the first predetermined temperature, the water supply line is close by turning off power when water level in the hot water furnace reaches the high water level sensor, the upper limit level sensor is above the high water level sensor, and when water level of the hot water furnace reaches the upper limit level sensor, the beverage preparation apparatus closes the water supply line, cuts off power of the heater and the hot water pump, and issues a warning.

In a preferred embodiment of the invention, each of the beverage preparation modules is a coffee brewing device including a dispenser and a container disposed at an underside of the dispenser.

In a preferred embodiment of the invention, the coffee brewing device further comprises a reservoir for storing hot water supplied from the hot water supply line, a heater in the reservoir, a temperature sensor in the reservoir, and at least one water level sensor; and wherein after heating water in the reservoir to a second predetermined temperature which is not less than the first predetermined temperature, hot water in the reservoir is supplied to the dispenser to prepare beverage via a hot water pump and a hot water supply line.

In a preferred embodiment of the invention, the dispenser is formed with the reservoir as a unit.

In a preferred embodiment of the invention, each of the beverage preparation modules is a filter-type brewing device including a sprayer and a container disposed at an underside of the sprayer.

In a preferred embodiment of the invention, the filter-type brewing device further comprises a reservoir for storing hot water supplied from the hot water supply line, a heater in the reservoir, a temperature sensor in the reservoir, and at least one water level sensor; and wherein after heating water in the reservoir to a third predetermined temperature which is not less than the first predetermined temperature, hot water in the reservoir is supplied to the sprayer to prepare beverage via a hot water pump and a hot water supply line.

In a preferred embodiment of the invention, further comprises an interconnection connected water supply lines of two adjacent reservoirs together, water in the two adjacent reservoirs being heated to two different temperature value, a solenoid valve for hot water being provided on each of the water supply lines, two branches of the interconnection connected two adjacent hot water sprayers, each of the branches of the interconnection being provided with a solenoid valve for branch for controlling opening or close of each of the branches, and by selectively opening of one of the two solenoid valves for hot water and selecting opening of one of the two solenoid valves for branch, hot water in any one of the reservoirs is configured to supply to any one of the hot water sprayers.

In a preferred embodiment of the invention, further comprises at least one hot water supply line mounted with the hot water branch for supplying hot water from the hot water branch to a predetermined destination.

In a preferred embodiment of the invention, further comprises at least one steam supply device mounted with the hot water branch, the steam supply device including a reservoir for storing hot water from the hot water branch, a heater in the reservoir, a steam pressure gauge in the reservoir, and at least one water level sensor in the reservoir, wherein in response to heating water in the reservoir to a predetermined steam pressure, on an upper portion of the reservoir a steam supply tube and a steam valve are configured to supply steam generated in the reservoir to an external destination.

In a preferred embodiment of the invention, further comprises a bypass connected to the hot water supply line, a standby hot water pump on the bypass, and a standby solenoid valve for water line on the bypass

In a preferred embodiment of the invention, further comprises a hot water pump on the hot water branch for water replenishment, and a flow meter.

In comparison with the conventional art, the invention has the following advantages: A beverage preparation apparatus having a central constant temperature water supply uses a central water supply to supply hot water to the beverage preparation modules for preparing a variety of beverages. The central water supply may more effectively maintain hot water at a predetermined temperature, supply a large quantity of hot water to brew beverages in a short period of time, greatly improve efficiency of the beverage preparation apparatus, and prepare various beverages of quality and good taste. It may preheat water to a first temperature in an off-peak time. It not only avoids the use of heating device of high power consumption but also utilizes a relatively inexpensive off-peak power, thereby effectively reducing beverage preparation cost.

### BRIEF DESCRIPTION OF THE DRAWINGS

The invention, as well as its many advantages, may be further understood by the following detailed description and drawings in which:

FIG. 1 schematically depicts a first preferred embodiment of a beverage preparation apparatus having a central constant temperature water supply according to the invention;

FIG. 2 schematically depicts the hot water furnace of the beverage preparation apparatus in an enlarged view;

FIG. 3 schematically depicts a second preferred embodiment of a beverage preparation apparatus having a central constant temperature water supply according to the invention;

FIG. 4 is a perspective view of the beverage preparation module and the hot water branch;

FIG. 5 is a perspective view of the beverage preparation module and the hot water branch of FIG. 4 mounted to a reservoir;

FIG. 6 is a perspective view of the filter-type brewing device;

FIG. 7 is a perspective view of the filter-type brewing device of FIG. 6 mounted to a reservoir;

FIG. 8 is a perspective view of the hot water branch;

FIG. 9 is a side view of the hot water branch and associated components mounted to a reservoir;

FIG. 10 is a side view of the reservoir and associated components;

FIG. 11 is a perspective view of another configuration of the hot water furnace of FIG. 2;

FIG. 12 is a perspective view showing two filter-type brewing devices connected together so that hot water of different temperatures may be supplied to either one; and

FIG. 13 is a perspective view of another configuration of beverage preparation module, hot water branch, and reservoir.

### DETAILED DESCRIPTION OF THE INVENTION

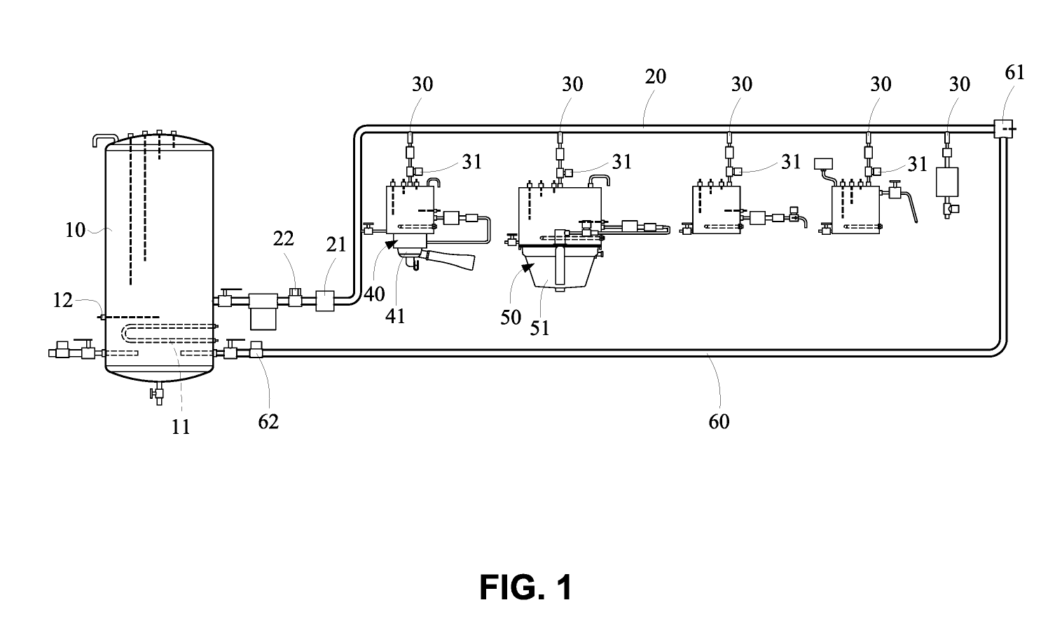

Referring to FIG. 1, a beverage preparation apparatus having a central constant temperature water supply beverage according to a first preferred embodiment of the invention comprises a hot water furnace 10 provided with a heater 11 for heating water in the hot water furnace 10 to a first predetermined temperature, and a first temperature sensor 12 for sensing water temperature in the hot water furnace 10; a hot water supply line 20 for flowing hot water out of the hot water furnace 10, the hot water supply line 20 provided with a hot water pump 21 for pumping hot water out of the hot water furnace 10 and a solenoid valve for water supply 22 for controlling opening or close of the hot water supply line 20; at least one hot water branch 30 connected to the hot water supply line 20, each hot water branch 30 provided with a solenoid valve for water branch 31 for controlling opening or close of the hot water branch 30; at least one beverage preparation module 40 (or 50) mounted to the hot water branch 30, the beverage preparation module 40 (or 50) provided with a container 41 (or 51) for storing predetermined beverage materials, when the corresponding solenoid valve for water branch 31 is turned on, hot water in the hot water supply line 20 flows into the container 41 (or 51) to mix with the beverage materials to prepare beverage; and a return pipe 60 interconnecting the hot water furnace 10 and the hot water supply line 20, the return pipe 60 provided with a second temperature sensor 61 and a solenoid valve for return pipe 62 for controlling opening or close of the return pipe 60.

At the beginning of supplying water, temperature of water in the hot water supply line 20 may be lower than the first predetermined temperature due to the remained hot water. Thus, the solenoid valves for water branch 31 are turned off and the solenoid valve for return pipe 62 is turned on so that hot water in the hot water supply line 20 may flow back to the hot water furnace 10 via the return pipe 60 until water temperature in the return pipe 60 measured by the second temperature sensor 61 is equal to the first predetermined temperature. Next, the solenoid valve for return pipe 62 is closed and a user may turn on one of the solenoid valves for water branch 31. Thus, hot water in the hot water supply line 20 may flow to the beverage preparation module 40 (or 50) for beverage preparation via the hot water branch 30 corresponding to the selected solenoid valve for water branch 31. The hot water supply line 20 may be provided for other hot water consumption devices such as automatic coffee makers or hot water machines. If a distance between a hot water consumption device and the hot water furnace 10 is too long, the hot water supply line 20 may be provided with an additional pump in series to ensure a continuous supply of hot water. Alternatively, no temperature sensor is provided in the solenoid valve for return pipe 60. The return pipe 60 may flow cold water from the hot water supply line 20 to the hot water furnace 10 after a long period of time of unused to ensure that the hot water supply line 20 is filled with hot water of the first predetermined temperature.

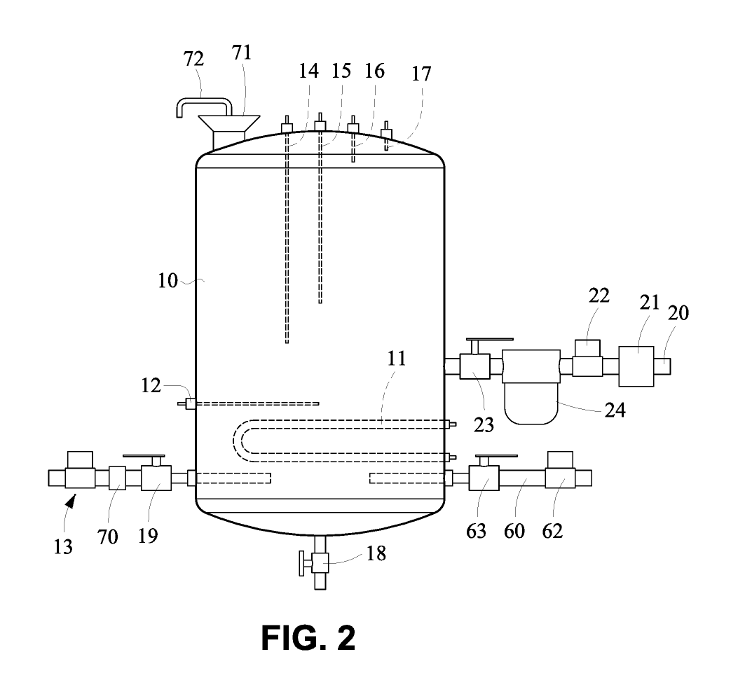

Referring to FIG. 2, the hot water furnace 10 is also provided with a water supply line 13 for additionally supplying water to the hot water furnace 10 and a plurality of water level sensors including a low water level sensor 14, an intermediate water level sensor 15, a high water level sensor 16 and an upper limit level sensor 17.

The low water level sensor 14 is slightly above the hot water inlet of the hot water supply line 20. When water level of the hot water furnace 10 is lower than the low water level sensor 14, the apparatus stops hot water supply to ensure that the hot water pump 21 does not run. Otherwise, it may be damaged.

When water level in the hot water furnace 10 rises above the low water level sensor 14, the apparatus closes the water inlet, deactivates the heater 11 and stops hot water supply. The apparatus will start again after turning off power and finishing the trouble shooting about abnormal water inflow. Light indicating no water is lit, alarm is off, the water supply line 13 supplies cold water to the hot water furnace 10, and the heater 11 beings to heat water. But hot water output is deactivated. After water level reaching the intermediate water level sensor 15, the water supply line 13 is cut off, the heater 11 heats water, the light changes to indicate water supply normal, hot supply resumes, and water inflow continues.

When water level in the hot water furnace 10 is higher than the intermediate water level sensor 15, no signal is sent by the apparatus. Hot water continues to output so that water level may be higher than the low water level sensor 14. In response, hot water stops to supply and signal of abnormal low water level is sent. After solving the problem, the water supply line 13 supplies water to the hot water furnace 10 again and water level rises to the intermediate water level sensor 15. Thereafter, water inflow stops, the heater 11 heats water, and the light indicates water heating. After water temperature reaching the predetermined upper limit, hot water output resumes, the light changes to indicate water inflow, and water continues to flow into the hot water furnace 10.

Volume of water between the intermediate water level sensor 15 and the low water level sensor 14 in the hot water furnace 10 is about the whole hot water consumption. Thus, it ensures that sufficient hot water can be supplied for consumption.

When water level in the hot water furnace 10 reaches the high level sensor 16, it is the normal water level of the hot water furnace 10. Thus, light indicating high water level is lit, and the heater 11 heats water until a predetermined temperature limit is reached. And in turn, the heater 11 is turned off by the first temperature sensor 13. In response to hot water consumption, both the hot water pump 21 and the solenoid valve for water supply 22 activate to output hot water. When water in the hot water furnace 10 falls below the high water level sensor 16, the apparatus continues to supply hot water and activates the water supply line 13. When the first temperature sensor 12 senses that hot water temperature is lower than the first predetermined temperature, the heater 11 activates and the water supply line 13 deactivates. When water reaches the high water level sensor 16, the water supply line 13 is cut off. Further, the heater 11 is deactivated after temperature reaching the first predetermined temperature.

Hot water continues to supply and the heater 11 remains being activated in the water replenishment. In the water replenishment, the water supply line 13 is cut off when the first temperature sensor 12 senses that hot water temperature is lower than the first predetermined temperature. The water supply line 13 activates when hot water temperature reaches the first predetermined temperature. The water replenishment continues and the heater 11 continues to heat water until water level reaches the high water level sensor 16. Thereafter, water inflow stops and the heater 11 deactivates.

The upper limit level sensor 17 is between the high water level sensor 16 and top of the hot water furnace 10. Water reaches the upper limit level sensor 17 when the water supply line 13 malfunctions or water replenishment is abnormal. Thereafter, the apparatus cuts off the hot water supply, stops water inflow and heating functions, and audibly and/or visually issues a warning. Otherwise, hot water may spill out of the hot water furnace 10 to hurt employees and/or waste energy. Light indicating abnormality and alarm returns to normal after solving the problems.

The water level sensors are contact switches for sensing water level in external vertical pipes which communicate with water in the hot water furnace 10.

A drain valve 18 is on an underside of the hot water furnace 10. The drain valve 18 is closed when the hot water furnace 10 is in use. Water valves 19, 63, and 23 are operated by handles and provided in the water supply line 13, the return pipe 60, and the hot water supply line 20 respectively. A check valve 70 is provided adjacent to the water valve 19 for preventing hot water in the hot water furnace 10 from flowing back to the water supply line 13. Pump or water tower may be used as source for supplying water to the water supply line 13. A manhole 71 is provided on top of the hot water furnace 10 for cleaning fouling in the hot water furnace 10. A vent pipe 72 extends out of the manhole 71.

Elevation of the return pipe 60 is the same as that of the water supply line 13 but lower than the heater 11 which is at a lower portion inside the hot water furnace 10.

Inlet of the hot water supply line 20 is higher than the heater 11 so that the heater 11 is prevented from heating when water level in the hot water furnace 10 is lower than the heater 11.

Hot water output of the hot water pump 21 is greater than the total consumption of the beverage preparation modules 40 and 50 and other hot water consumption devices of the apparatus in order to ensure that hot water supply to the beverage preparation modules 40 and 50 is sufficient.

Fouling may form on the inner surface of the hot water furnace 10 after a period time of use. Thus, a debris filter 24 is provided adjacent to the water valve 23 for preventing the fouling materials from entering the hot water supply line 20 so as to prolong the useful life of the apparatus and improve water quality.

The first temperature sensor 12 is provided through the hot water furnace 10 and at an elevation between the water supply line 13 and the hot water supply line 20. Both the water supply line 13 and the first temperature sensor 12 under the hot water supply line 20 ensure that cold water will not mix with hot water at inlet of the hot water supply line 20.

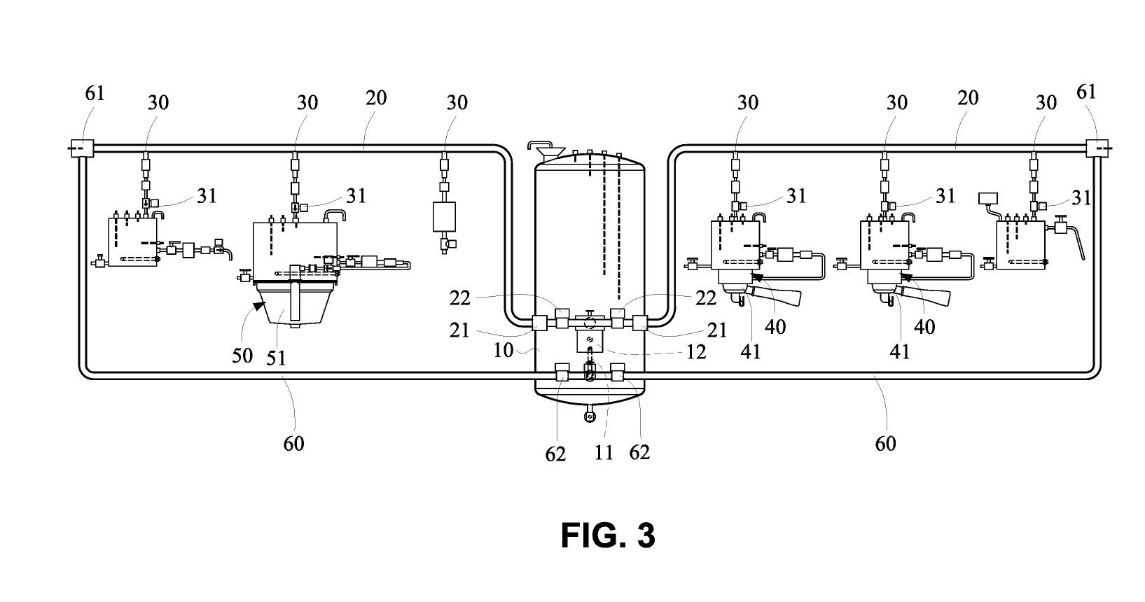

Referring to FIG. 3, a beverage preparation apparatus having a central constant temperature water supply beverage according to a second preferred embodiment of the invention is shown and characterized below. Two sets of hot water supply line 20 and return pipe 60 are provided to satisfy the user's needs or the requirements of space design. As shown, one set of hot water supply line 20 and return pipe 60 is at left and the other set of hot water supply line 20 and return pipe 60 is at right. At least one hot water branch 30 and at least one beverage preparation module 40 (or 50) are connected to each hot water supply line 20.

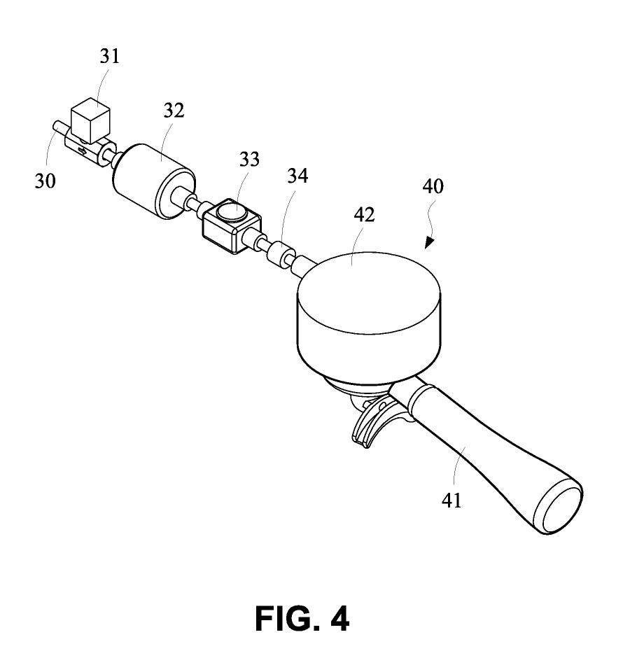

Referring to FIG. 4, the beverage preparation module 40 is implemented as a coffee brewing device including a dispenser 42 and a container 41 provided at an underside of the dispenser 42. On the hot water branch 30, there are provided, in addition to the solenoid valve for water branch 31, a hot water pump 32, a flow meter 33, and a connector 34 for flowing a predetermined quantity of hot water having a predetermined temperature to the dispenser 42 and in turn to the container 41. Finally, the hot water is mixed with beverage materials in the container 41 to prepare beverage.

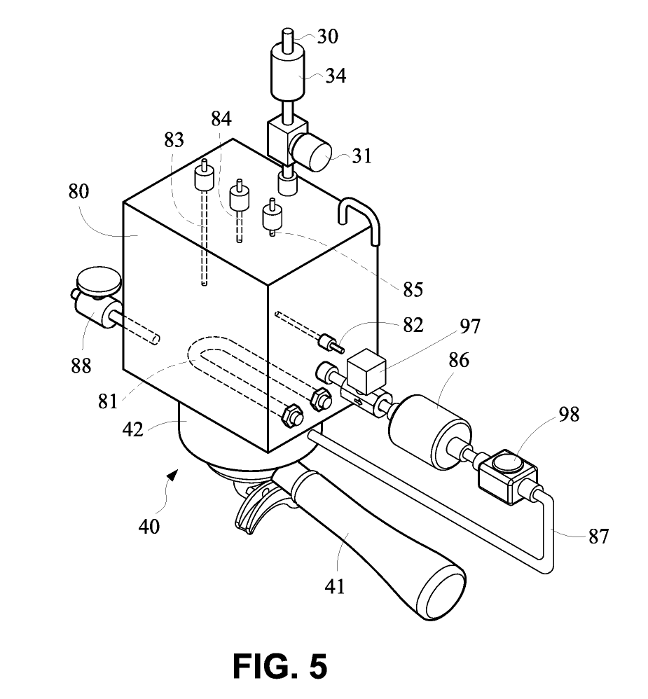

Referring to FIG. 5, the beverage preparation module 40 is mounted with a reservoir 80 which can store hot water supplied from the hot water branch 30. There are further provided with a heater 81, a temperature sensor 82 and a plurality of water level sensor 83, 84 and 85. Water in the reservoir 80 is heated to a second predetermined temperature which is not less than the first predetermined temperature. And in turn, the hot water is supplied to the dispenser 42 under the reservoir 80 via a hot water pump 86, a solenoid valve 97 for hot water, a flow meter 98, and a hot water supply line 87. Finally, the hot water is mixed with beverage materials in the container 41 to prepare beverage.

In a preferred embodiment, the reservoir 80 is provided with a low water level sensor 83, a high water level sensor 84 and an upper limit level sensor 85. The high water level sensor 84 is at normal water level and there is a distance between itself and the top of the reservoir 80. Water replenishment begins after water falls under the high water level sensor 84. Also, the solenoid valve for water branch 31 activates for water replenishment. The water replenishment stops when water level reaches the high water level sensor 84. Water replenishment and water supply may occur at the same time while hot water being supplied.

Bottom of the low water level sensor 83 is higher than inlet of the hot water supply line 87. Preferably, water volume between the bottom of the low water level sensor 83 and inlet of the hot water supply line 87 is sufficient to supply hot water to the beverage preparation module 40 for a brewing operation. Quantity of hot water is sufficient for a single brewing operation if water level is lower than the low water level sensor 83. Thereafter, the hot water supply is cut off to ensure there is sufficient hot water for subsequent brewing operation in a low water level condition and ensure there is water in the reservoir 80 when hot water supply has been cut off.

Light indicating abnormality and/or alarm may be activated when water level is lower than the low water level sensor 83. Hot water is stopped from supplying to the beverage preparation module 40 after finishing brewing operation. Further, water replenishment begins until water level rises to the high water level sensor 84 and water is heated to a second predetermined temperature which is not lower than the first predetermined temperature. Thereafter, hot water supply to the beverage preparation module 40 resumes.

When water level in the reservoir 80 rises to the upper limit level sensor 85 due to abnormal water inflow, the beverage preparation module 40 is deactivated and light indicating abnormality and/or alarm may be activated. After solving the problem and lowering water level to a position under the high water level sensor 84 by opening the drain valve 88, water begins to supply again until water level reaches the high water level sensor 84. Thereafter, light indicating abnormality and/or alarm are deactivated and the hot water output to the beverage preparation module 40 resumes after hot water temperature reaches the predetermined temperature.

In case of multiple hot water consumption devices connected to the hot water supply line 20, hot water temperature is set at 95° C., i.e., the first predetermined temperature is 95° C. For hot water supplied at 85° C., cold water pipe may be connected to the reservoir 80 so as to supply hot water at 85° C. by mixing cold water with hot water of 95° C.

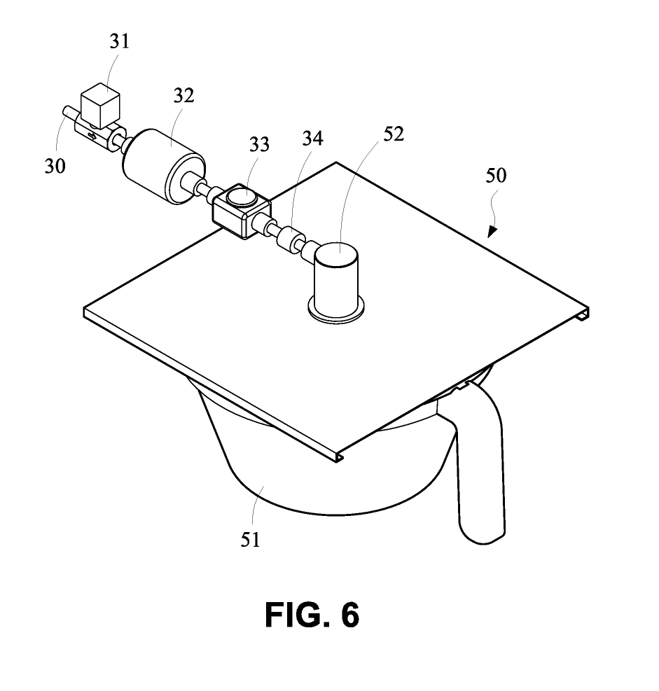

Referring to FIG. 6, the beverage preparation module 50 is implemented as a filter-type brewing device and includes a sprayer 52 and a container 51 provided at an underside of the sprayer 52. On the hot water branch 30, there are provided, in addition to the solenoid valve for water branch 31, a hot water pump 32, a flow meter 33, and a connector 34 for flowing a predetermined quantity of hot water having a predetermined temperature to the spryer 52 and in turn to the container 51. Finally, the hot water is mixed with beverage materials in the container 51 to prepare beverage.

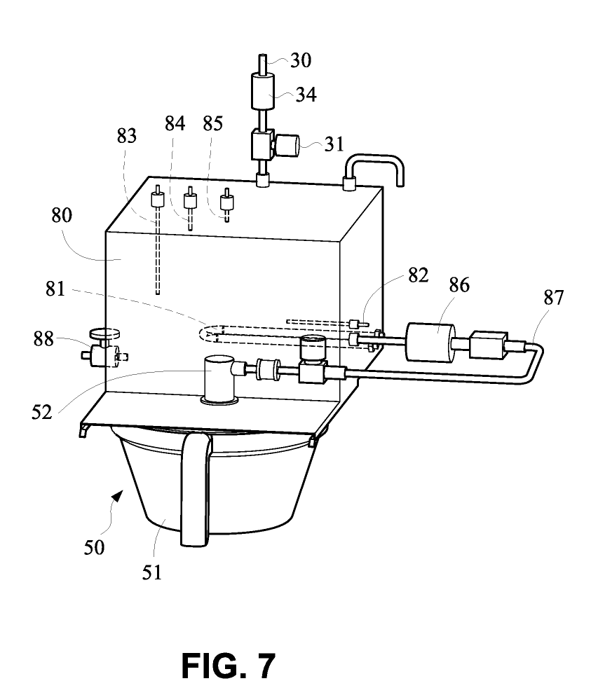

Referring to FIG. 7, the beverage preparation module 50 is mounted with a reservoir 80 which is the same as that described in reference to FIG. 5. Thus, a detailed description thereof is omitted for the sake of brevity.

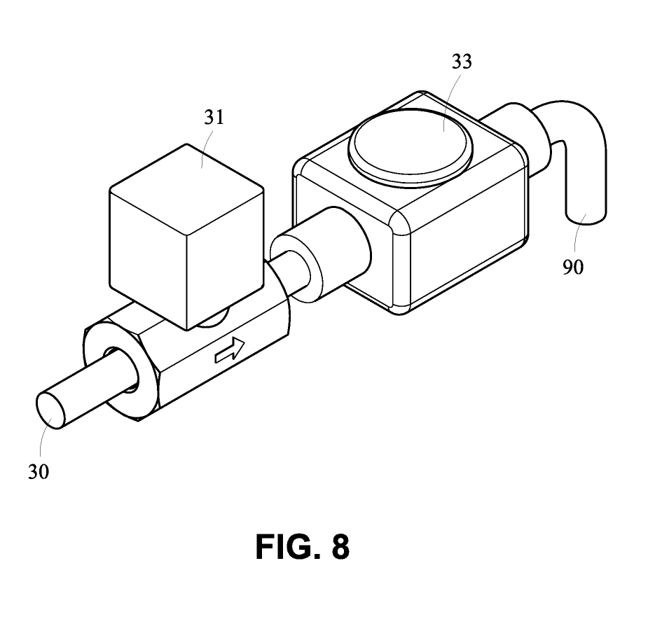

Referring to FIG. 8, the beverage preparation apparatus having a central constant temperature water supply beverage further comprises at least one hot water supply line 90 mounted with the hot water branch 30 for supplying hot water from the hot water branch 30 to a predetermined destination. In addition to the solenoid valve for water branch 31, on the hot water branch 30 there is provided a flow meter 33 for measuring the quantity of hot water to be supplied.

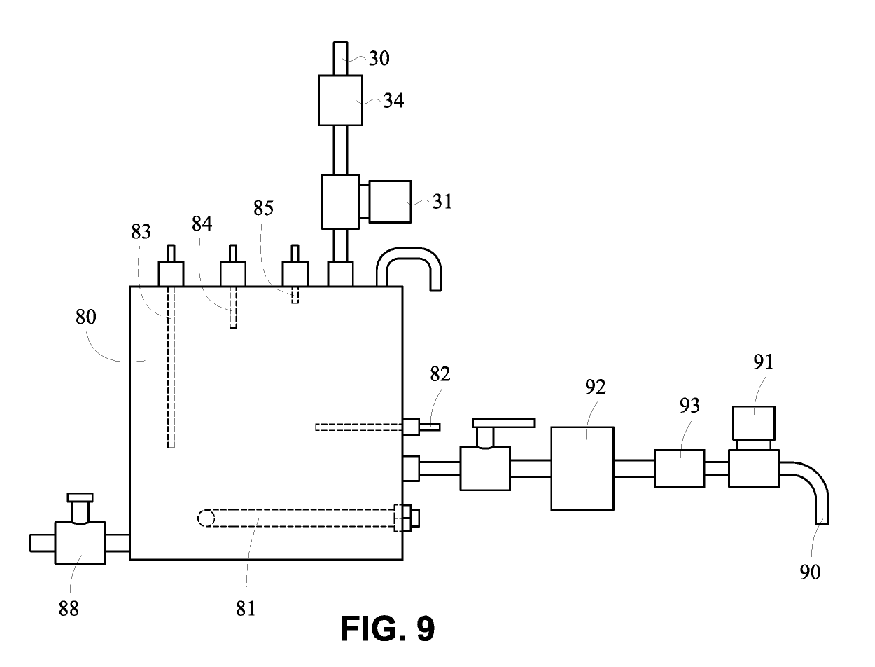

Referring to FIG. 9, the hot water supply line 90 is mounted with a reservoir 80 which is the same as that described in reference to FIG. 5. Thus, a detailed description thereof is omitted for the sake of brevity. On the hot water supply line 90 there are provided a solenoid valve for water supply line 91, a hot water pump 92, and a flow meter 93 for measuring the quantity of hot water to be supplied.

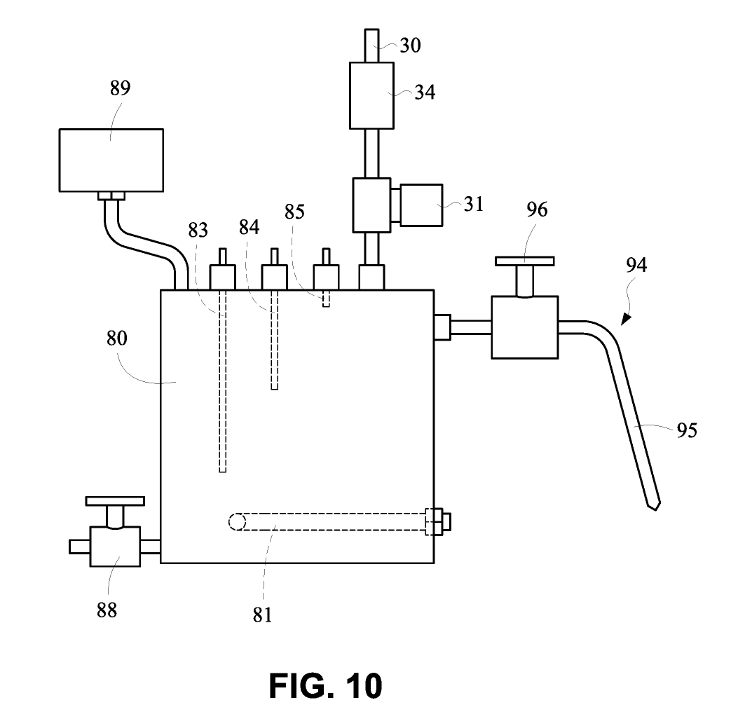

Referring to FIG. 10, the beverage preparation apparatus having a central constant temperature water supply beverage also comprises at least one steam supply device 94 mounted with the hot water branch 30. The steam supply device 94 includes a reservoir 80 for storing hot water from the hot water branch 30. In the reservoir 80, there are provided with a heater 81, a steam pressure gauge 89, and at least one water level sensors 83, 84 and 85. In the reservoir 80, water is heated to a predetermined steam pressure (e.g., 1 to 1.2 BAR). Next, on an upper portion of the reservoir 80 a steam supply tube 95 and a steam valve 96 are configured to control the steam pressure to the predetermined valve. The steam valve 96 may be a manual valve or a solenoid valve and is adapted to supply steam generated in the reservoir 80 to an external destination.

Other hot water consumption devices can also be installed in the hot water supply line 20.

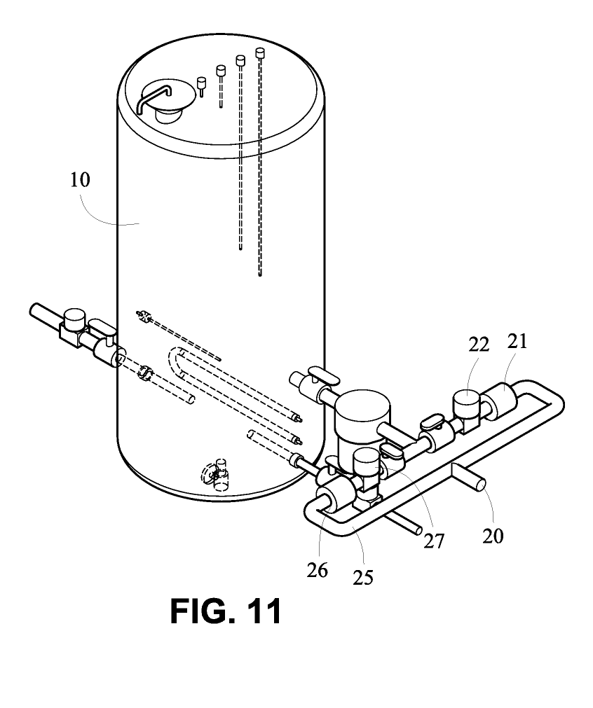

Referring to FIG. 11, the hot water supply line 20 is further provided with a bypass 25. On the bypass 25 there are provided with a standby hot water pump 26 and a standby solenoid valve for water line 27. The standby hot water pump 26 and a standby solenoid valve for water line 27 are used to flow hot water out of the hot water furnace 10 and supply same to the hot water branches 30 when the hot water pump 21 and the solenoid valve for water supply 22 are off for maintenance. Alternatively, the two sets of hot water supply are used in alternate. That is, one set of hot water supply is used and the other set is off for maintenance and vice versa. This ensures that hot water can be supplied normally and a prolonged service life can be obtained.

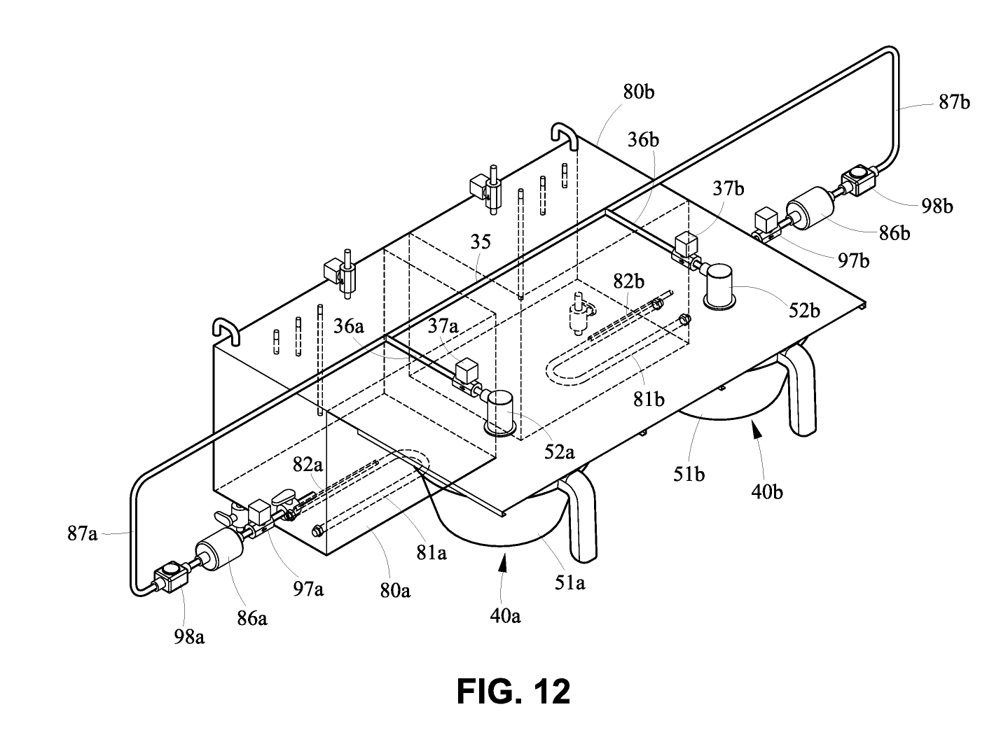

Referring to FIG. 12, an interconnection 35 connects water supply lines 87a and 87b of two adjacent reservoirs 80a and 80 together. The two adjacent reservoirs 80a and 80b are respectively provided with heaters 81a and 81b and temperature sensors 82a and 82b so that hot water having temperature 85° C. in the reservoir 80a and hot water having temperature 95° C. in reservoir 80a are supplied to the interconnection 35 via the hot water pumps 86a and 86b, solenoid valves for hot water 97a and 97b, and flow meters 98a and 98b, and water supply lines 87a and 87b. The interconnection 35 has two tees 36a and 36b connected to the two adjacent beverage preparation modules 40a and 40b respectively. Each of the tees 36a and 36b are provided with a solenoid valve 37a or 37b for controlling opening or close of the tees. By selecting opening of one of the two solenoid valves for hot water 97a and 97b and selecting opening of one of the two solenoid valves 37a and 37b for tees, hot water in any one of the reservoirs 80a and 80b can be delivered to any one of the beverage preparation modules 40a and 40b such that it can receive hot water having different temperature values (e.g., 85° C. and 95° C.). Hot water is supplied through the hot water sprayers 52a and 52b to evenly spray into the containers 51a and 51b respectively. Thus, hot water is mixed with beverage materials in the containers 51a and 51b to prepare different beverages (such as black tea and green tea).

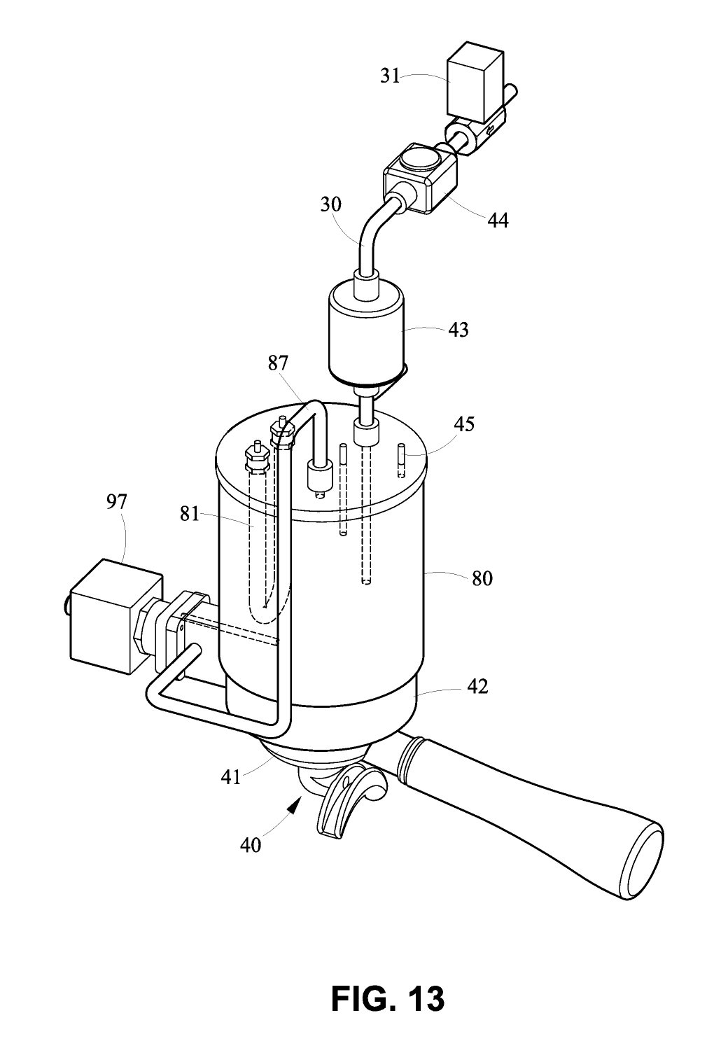

Referring now to FIG. 13, in case of no water level sensors, after filling the reservoir 80 to its fullness, beverage preparation operation is performed immediately. The hot water branch 30 further includes a hot water pump 43 for filling the reservoir 80 to its fullness, and a flow meter 44. In an operation of brewing beverage, the hot water pump 43, the solenoid valve for tees 31 and the solenoid valve for hot water 97 are activated. The flow meter 44 measures water flow. Hot water is pumped by the hot water pump 43 to supply to the reservoir 80 for storage via the hot water branch 30. Water is heated by the heater 81 and the heated water flows to the water hot water supply line 87, the solenoid valve for hot water 97, the dispenser 42, and the container 41 for brewing coffee. Additionally, a short water level sensor 45 is on top of the reservoir 80 so that the heater 81 activates only when full water level is sensed.

As used herein, hot water devices, such as hot water lines, hot water furnace, and reservoir and the like may be coated by insulation materials to reduce heat loss.

The invention of beverage preparation apparatus with central constant temperature water supply employs a central water supply system to supply warm water to each beverage preparation module for preparing various beverages. The central water supply apparatus may more effectively maintain hot water at a predetermined temperature, supply a large quantity of hot water to brew beverages in a short period of time, greatly improve efficiency of the beverage preparation apparatus, and prepare various beverages of quality and good taste. Moreover, the central water supply system may preheat water to a first temperature in an off-peak time. It not only avoids the use of heating device of high power consumption but also utilizes a relatively inexpensive off-peak power, thereby effectively reducing beverage preparation cost.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A beverage preparation apparatus comprising:
a hot water furnace for storing a quantity of water, the hot water furnace including a heater for heating water in the hot water furnace to a first predetermined temperature, and a first temperature sensor for sensing water temperature in the hot water furnace;
at least one hot water supply line for flowing hot water out of the hot water furnace, the hot water supply line including a hot water pump for pumping hot water out of the hot water furnace and a solenoid valve for water supply for controlling opening or close of the hot water supply line;
at least one hot water branch connected to the hot water supply line, each of the at least one hot water branch including a solenoid valve for water branch for controlling opening or close of the hot water branch;
at least one beverage preparation module mounted to the hot water branches, each of the at least one beverage preparation module including a container for storing predetermined beverage materials wherein when the corresponding solenoid valve for water branch is open, hot water in the hot water supply line flows into the container to mix with the beverage materials to prepare beverage; and
a return pipe interconnecting the hot water furnace and the hot water supply line, the return pipe including a second temperature sensor and a solenoid valve for return pipe for controlling opening or close of the return pipe;
wherein in response to flowing hot water to the hot water supply line, the solenoid valves for water branch are closed and the solenoid valve for return pipe is open so that hot water in the hot water supply line is configured to flow to the hot water furnace via the return pipe; and the hot water flow stops when the second temperature sensor senses temperature of the hot water flow in the return pipe is equal to the first predetermined temperature.
The beverage preparation apparatus of claim 1, further comprising a water supply line for flowing cold water to the hot water furnace, and a plurality of water level sensors for sensing water level in the hot water furnace; wherein the plurality of water level sensors include a low water level sensor, an intermediate water level sensor, a high water level sensor, and an upper limit level sensor; and wherein the low water level sensor is slightly above the water supply line, when water level of the hot water furnace is lower than the low water level sensor, the beverage preparation apparatus stops hot water supply, cuts off power of the heater and the hot water pump, and issues a warning, after stopping issuing the warning and water level in the hot water furnace reaching the intermediate water level sensor, the water supply line is close by turning off power, the heater heats water, the water supply line supplies cold water to the hot water furnace again when the first temperature sensor senses water temperature in the hot water furnace is equal to the first predetermined temperature, the water supply line is close by turning off power when water level in the hot water furnace reaches the high water level sensor, the upper limit level sensor is above the high water level sensor, and when water level of the hot water furnace reaches the upper limit level sensor, the beverage preparation apparatus closes the water supply line, cuts off power of the heater and the hot water pump, and issues a warning.

3. The beverage preparation apparatus of claim 1, wherein each of the beverage preparation modules is a coffee brewing device including a dispenser and a container disposed at an underside of the dispenser.

4. The beverage preparation apparatus of claim 3, wherein the coffee brewing device further comprises a reservoir for storing hot water supplied from the hot water supply line, a heater in the reservoir, a temperature sensor in the reservoir, and at least one water level sensor; and wherein after heating water in the reservoir to a second predetermined temperature which is not less than the first predetermined temperature, hot water in the reservoir is supplied to the dispenser to prepare beverage via a hot water pump and a hot water supply line.

5. The beverage preparation apparatus of claim 3, wherein the dispenser is formed with the reservoir as a unit.

6. The beverage preparation apparatus of claim 1, wherein each of the beverage preparation modules is a filter-type brewing device including a sprayer and a container disposed at an underside of the sprayer.

7. The beverage preparation apparatus of claim 6, wherein the filter-type brewing device further comprises a reservoir for storing hot water supplied from the hot water supply line, a heater in the reservoir, a temperature sensor in the reservoir, and at least one water level sensor; and wherein after heating water in the reservoir to a third predetermined temperature which is not less than the first predetermined temperature, hot water in the reservoir is supplied to the sprayer to prepare beverage via a hot water pump and a hot water supply line.

8. The beverage preparation apparatus of claim 7, further comprising an interconnection connected water supply lines of two adjacent reservoirs together, water in the two adjacent reservoirs being heated to two different temperature value, a solenoid valve for hot water being provided on each of the water supply lines, two branches of the interconnection connected two adjacent hot water sprayers, each of the branches of the interconnection being provided with a solenoid valve for branch for controlling opening or close of each of the branches, and by selectively opening of one of the two solenoid valves for hot water and selecting opening of one of the two solenoid valves for branch, hot water in any one of the reservoirs is configured to supply to any one of the hot water sprayers.

9. The beverage preparation apparatus of claim 1, further comprising at least one hot water supply line mounted with the hot water branch for supplying hot water from the hot water branch to a predetermined destination.

10. The beverage preparation apparatus of claim 1, further comprises at least one steam supply device mounted with the hot water branch, the steam supply device including a reservoir for storing hot water from the hot water branch, a heater in the reservoir, a steam pressure gauge in the reservoir, and at least one water level sensor in the reservoir, wherein in response to heating water in the reservoir to a predetermined steam pressure, on an upper portion of the reservoir a steam supply tube and a steam valve are configured to supply steam generated in the reservoir to an external destination.

11. The beverage preparation apparatus of claim 1, further comprising a bypass connected to the hot water supply line, a standby hot water pump on the bypass, and a standby solenoid valve for water supply.

12. The beverage preparation apparatus of claim 1, further comprising a hot water pump for replenishment and a flow meter both on the hot water branch.
